(19) United States
(12) Patent Application Publication
(10) Pub. No.: US 2002/0076314 A1
(43) Pub. Date: Jun. 20, 2002

(54) Towable work vehicle

(76) Inventors: C. Christopher Zanetis, Brownsburg, IN (US); Jeff Schultz, Montevideo, MN (US); David Struxness, Clara City, MN (US); John Robert, Starbuck, MN (US); Leland Erickson, Willmar, MN (US)

Correspondence Address: Michael D. Beck, Baker & Daniels, Suite 2700, 300 N. Meridian Street, Indianapolis, IN, 46204, US

(21) Appl. No.: 09/740,237

(22) Filed: Dec. 18, 2000

(51) Int. Cl. B66C 23/00

(52) U.S. Cl. 414/680

(57) ABSTRACT

A work vehicle adapted to be towed from one job site to the next at highway speeds, and then converted upon reaching a job site to be self-propelling. The towable work vehicle includes lift arms with an attachment system allowing for ready attachment to, and detachment from, a variety of materials handling attachments that are used to perform diverse tasks at the job site. Tow arms attachable to the towing vehicle may be swept forward when not in use to a position underneath the vehicle so as to not interfere with work operations at the job site. A ballast system in one form uses movable weights to allow redistribution of weight on the vehicle to convert the vehicle between towing and operational modes, and in another form uses a fluid fillable tank to allow ballast to be added for use of the vehicle on a job site.

### FIELD OF THE INVENTION

The present invention pertains to work vehicles capable of performing construction tasks at a job site, and, in particular, to a work vehicle designed to be both self-propelled at a job site and towable at highway speeds to the next job site at which its capabilities are required.

### BACKGROUND OF THE INVENTION

A wide variety of work vehicles have been developed to aid their operators in the performance of construction tasks at various job sites. One type of work vehicle known as a skid steer loader is a workhorse within the industry. Skid steer loaders include raisable and lowerable lift arms that can be equipped with various materials handling attachments, such as buckets, planers and grinders. These attachments have been designed in conjunction with a quick attach system mountable on the lift arms, whereby the attachments are readily interchangeable on the lift arms by the operator at the job site. This interchangeability provides a single skid steer loader with the versatility to perform various diverse tasks at a job site.

While extremely useful, existing skid steer loaders are not without their shortcomings. For instance, the overall size and complexity, and therefore the total cost, of a skid steer loader is often larger than necessary for smaller jobs where less assistance is required. Another significant shortcoming of loaders relates to their limited transportability. While a self-propelled skid steer loader is maneuverable around a job site, transporting the skid steer loader over the highway from one job site to the next typically requires a trailer on which the unit is loaded and then secured for transport. Because the drive wheels or other ground-engaging drive means of skid steer loaders, and other types of loaders, are typically rotatably coupled to the hydraulic motors which power their rotation to achieve vehicle self-propulsion, most loaders cannot be simply towed on the highway behind a vehicle such as a truck.

To avoid the need for a separate trailer to transport skid steer loaders or other types of loaders, various loader-attachable tow kits have been designed. Such kits often provide a free-wheeling wheeled axle mountable to the loader, which loader can then be hitched to and pulled behind a towing vehicle, with the free-wheeling kit wheels in contact with the road surface, and with the drive wheels of the loader spaced from the road surface. Unfortunately, these tow kits introduce large additional parts that must be safely stowed at job sites when taken off and not in use, and may be inconvenient and cumbersome to install and remove in the field.

In addition to skid steer loaders, another construction apparatus that has been developed is a towable backhoe, as generally disclosed in U.S. Pat. No. 4,925,358. In a commercial embodiment of this backhoe, the ability to self-propel the backhoe around a work site has been achieved via hydraulic-motor powered drive wheels connected to controls operable from the backhoe seat, which drive wheels include lockout hubs to disengage the drive wheels from the motors to allow the backhoe to be towed between job sites with the drive wheels engaging the road in a free-wheeling mode. While useful in some situations where backhoe digging is required, this construction apparatus is basically limited to such operations. Moreover, while the tow bar assembly used to hitch the apparatus to a towing vehicle may be vertically folded up relative to the frame at the job site to not interfere with items on the ground when self-propelling at a job site, such upward folding may be difficult for some users due to the weight of the tow bar assembly. In addition, the tow bar assembly when folded upward extends high into the air and can interfere with the operation of the backhoe in places with low overhead clearance.

One problem with towable work apparatuses is the difficulty of providing an apparatus with sufficient weight to satisfactorily perform its work operations, while at the same time providing an apparatus which is not so heavy as to make its towing impractical by some smaller vehicles. Weighting systems have been employed for many years in the construction equipment industry to properly ballast an apparatus for its intended purpose to achieve the rated capacity of lift. However, such weighting systems may pose problems if the apparatus is to be towed. In particular, if the amount of the apparatus weight acting downward on the tow assembly in the tow mode is too great, smaller vehicles may be unable to tow the apparatus.

Thus, it would be desirable to provide a work vehicle which overcomes these and other shortcomings of the prior art.

### SUMMARY OF THE INVENTION

The present invention provides a work vehicle adapted to be towed from one job site to the next at highway speeds, and then converted upon reaching a job site to be self-propelling. The towable work vehicle includes lift arms with an attachment system allowing for ready attachment to, and detachment from, a variety of materials handling tools, such as a planer and bucket, that are used to perform diverse tasks at the job site. Tow arms attachable to the towing vehicle may be swept forward when not in use to a position underneath the work vehicle so as to not interfere with work operations at the job site. A mobile ballast system allows redistribution of weight on the vehicle to convert the vehicle between towing and operational modes.

In one form thereof, the present invention provides a work vehicle including a body having a forward end, a rearward end and a length extending between the forward end and the rearward end, the body including an operator station, at least one lift arm assembly mounted to the body to be movable between a raised position and a lowered position, an attachment assembly for the at least one lift arm assembly to which any one of a plurality of different complementarily configured materials handling attachments is interchangeably attachable, a tow element at the body rearward end for connection to an automobile-type towing vehicle behind which the work vehicle is towable between job sites directly on a road at highway speed, and ground engaging means at first and second locations along the body length. The ground engaging means at the first location include first and second ground engaging drive wheels respectively disposed on opposite sides of the body and convertible between a self-propelling mode and a free-wheeling mode, which first and second ground engaging drive wheels when in the self-propelling mode are operably connected to at least one work vehicle motor and controllable by an operator in the operator station to self-propel the work vehicle around a job site. The first and second ground-engaging drive wheels when in the free-wheeling mode are in direct engagement with the road during towing.

In another form thereof, the present invention provides a towing apparatus for a work vehicle self-propellable at a job site and towable between job sites directly on a road at highway speeds behind an automobile-type towing vehicle, the work vehicle including at least two road engaging drive wheels convertible between a self-propelling mode and a free-wheeling mode, wherein when in a self-propelling mode the drive wheels are operably connected to at least one work vehicle motor to be driven in a manner controlled by an operator on the work vehicle, and wherein when in a free-wheeling mode the drive wheels are operably disconnected from the at least one work vehicle motor to rotate independently thereof and in direct engagement with the road during towing. The towing apparatus includes at least one tow arm and a hitch member. The at least one tow arm includes a pivot connection to the work vehicle and is swingable in a generally horizontal plane about the pivot connection between a retracted position and a towing position. The hitch member on the at least one tow arm is connectable to a complementary hitch element on the towing vehicle.

In still another form thereof, the present invention is in a self-propelled work vehicle adapted to be towable between job sites directly on a road at highway speeds behind an automobile-type towing vehicle, and is a towing apparatus including a first tow arm pivotally connected to a frame of the work vehicle, a second tow arm pivotally connected to the frame of the work vehicle, the pivotal connections of the first and second tow arms to the frame located on opposite sides of a longitudinal centerline of the work vehicle, each of the first tow arm and the second tow arm swingable about its respective pivotal connection to the frame between first and second positions, wherein the first position is a rearwardly extending position at which the first and second tow arms are interconnected for work vehicle towing, and wherein the second position is a swept forward position for work vehicle operation. The towing apparatus also includes a hitch member on the first tow arm and connectable to a complementary hitch element on the towing vehicle when the first tow arm is arranged in the rearwardly extending position.

In still another form thereof, the present invention provides a work vehicle including a body having a forward end, a rearward end and a length extending between the forward end and the rearward end, the body including an operator station, at least one lift arm assembly movably mounted to the body to raise and lower a materials handling attachment at the body forward end, a tow element at the body rearward end for connection to an automobile-type towing vehicle behind which the work vehicle is towable between job sites directly on a road at highway speed, and ground engaging means at first and second locations along the body length. The ground engaging means at the first location includes first and second ground engaging drive wheels respectively disposed on opposite sides of the body and convertible between a self-propelling mode and a free-wheeling mode, the first and second ground engaging drive wheels when in the self-propelling mode being operably connected to at least one work vehicle motor and controllable by an operator in the operator station to self-propel the work vehicle around a job site. The work vehicle also includes a first rack member located on the body rearward of at least one of the first location and the second location, a second rack member located on the body forward of the first rack member, and a plurality of weights adapted to be loaded on either of the first rack member and the second rack member, which weights are selectively movable between the first and second rack members to adjust a weight distribution of the work vehicle, wherein the plurality of weights when loaded on the first rack member serve as a counterweight to the materials handling attachment during self-propelling of the work vehicle, and wherein the plurality or weights when loaded on the second rack member serve to limit weight acting down on the tow element during towing.

In yet another form thereof, the present invention can contemplate a work vehicle including a body having a forward end, a rearward end and a length extending between the forward end and the rearward end, the body including an operator station, at least one lift arm assembly movably mounted to the body to raise and lower a materials handling attachment at the body forward end, a tow element at the body rearward end for connection to an automobile-type towing vehicle behind which the work vehicle is towable between job sites directly on a road at highway speed, and ground engaging means at first and second locations along the body length, the ground engaging means at the first location including first and second ground engaging drive wheels respectively disposed on opposite sides of the body and convertible between a self-propelling mode and a free-wheeling mode, the first and second ground engaging drive wheels when in the self-propelling mode being operably connected to at least one work vehicle motor and controllable by an operator in the operator station to self-propel the work vehicle around a job site. The work vehicle also includes a ballast tank with a fluid fillable internal volume located on the body rearward of at least one of the first location and the second location, the tank having at least one opening in communication with the internal volume for inletting and outletting fluid, wherein an introduction of fluid into the tank internal volume through the at least one opening at a job site provides a counterweight to the materials handling attachment during self-propelling of the work vehicle, and wherein a draining of fluid from the tank internal volume through the at least one opening reduces vehicle weight for towing between job sites.

One advantage of the present invention is that a self-propelled work vehicle is provided with interchangeable materials handling attachments to allow various tasks to be performed at a job site, which vehicle is adapted to be towed, rather than hauled, behind an automobile-type vehicle to another job site where one or more of its various capabilities are required.

Another advantage of the present invention is that a tow assembly attachable to a towing vehicle is provided that can be stored at a location under the chassis of the work vehicle to not interfere with the view of the operator or the function of the work vehicle, as the stored tow assembly is not in the operator's line of sight and will not strike objects laterally of the work vehicle during its operation.

Still another advantage of the present invention is that a work vehicle is provided including drive wheels which can be converted between a freely rotatable towing mode and an operational drive mode, but which drive wheels when in the drive mode cannot be propelled unless an operator restraint is properly actuated, preferably via a kill switch.

Still another advantage of the present invention is that a relocatable ballast system is provided for weight distribution changes to convert the vehicle between a towing mode and an operational mode.

### BRIEF DESCRIPTION OF THE DRAWINGS

The above mentioned and other advantages and objects of this invention, and the manner of attaining them, will become more apparent and the invention itself will be better understood by reference to the following descriptions of embodiments of the invention taken in conjunction with the accompanying drawings, wherein:

FIG. 1 is a front perspective view of one embodiment of a work vehicle of the present invention;

FIG. 2 is a side elevational view of the work vehicle of FIG. 2 with a bucket for materials handling operably attached to the vehicle lift arms, which lift arms are shown after having been moved to a raised arrangement;

FIG. 3 is a perspective view of one suitable frame assembly of the work vehicle of FIG. 1 to which tow arms and ballast racks are shown installed;

FIG. 4 is a rear perspective view of a quick attach system shown removed from the work vehicle;

FIG. 5 is a block schematic diagram of the principal components involved in one form of the powering and controlling of the work vehicle of FIG. 1;

FIG. 6 is an enlarged, partial perspective view of a portion of the drive train of one of the driven vehicle wheels and its associated braking assembly;

FIG. 7 is a perspective view of portions of the axle subassembly used with the frame assembly of FIG. 3;

FIG. 8 is a partial perspective view of the work vehicle of FIG. 1 depicting an operator restraint in an operational position that is operably attached to the braking assembly of FIG. 6;

FIG. 9 is a partial rear perspective view of the work vehicle of FIG. 1, wherein a portion of the cover has been removed to expose the rearward ballast rack loaded with the relocatable ballast of one form of the present invention;

FIG. 10 is a partial, front perspective view of the work vehicle of FIG. 1 showing a forward ballast rack;

FIG. 11 is a perspective view of the ballast rack of FIG. 10 after some of the ballast has been relocated thereto from the rearward rack shown in FIG. 9;

FIG. 12 is a rear, top perspective view of a fluid fillable tank removed from the remainder of the work vehicle and which is employed in an alternate ballast system;

FIG. 13 is a front, bottom perspective view of the fluid fillable tank of FIG. 12;

FIG. 14 is a rear perspective view of a tow assembly of the work vehicle of FIG. 1 oriented in a rearwardly extending, towing arrangement;

FIG. 15 is an enlarged perspective view of portions of the tow assembly of FIG. 14;

FIG. 16 is a bottom perspective view of portions of the left tow arm of the tow assembly of FIG. 14 after being swept forward to a storage location under the vehicle frame; and

FIG. 17 is a bottom perspective view of portions of the right tow arm of the tow assembly of FIG. 14 after being swept forward to a storage location under the vehicle frame.

Corresponding reference characters indicate corresponding parts throughout the several views. Although the drawings represent embodiments of the invention, the drawings are not necessarily to scale and certain features may be exaggerated or omitted in order to better illustrate and explain the present invention.

### DESCRIPTION OF THE PREFERRED EMBODIMENTS

The embodiments disclosed below are not intended to be exhaustive or limit the invention to the precise forms disclosed in the following detailed description. Rather, the embodiments are chosen and described so that others skilled in the art may better utilize the teachings of the invention.

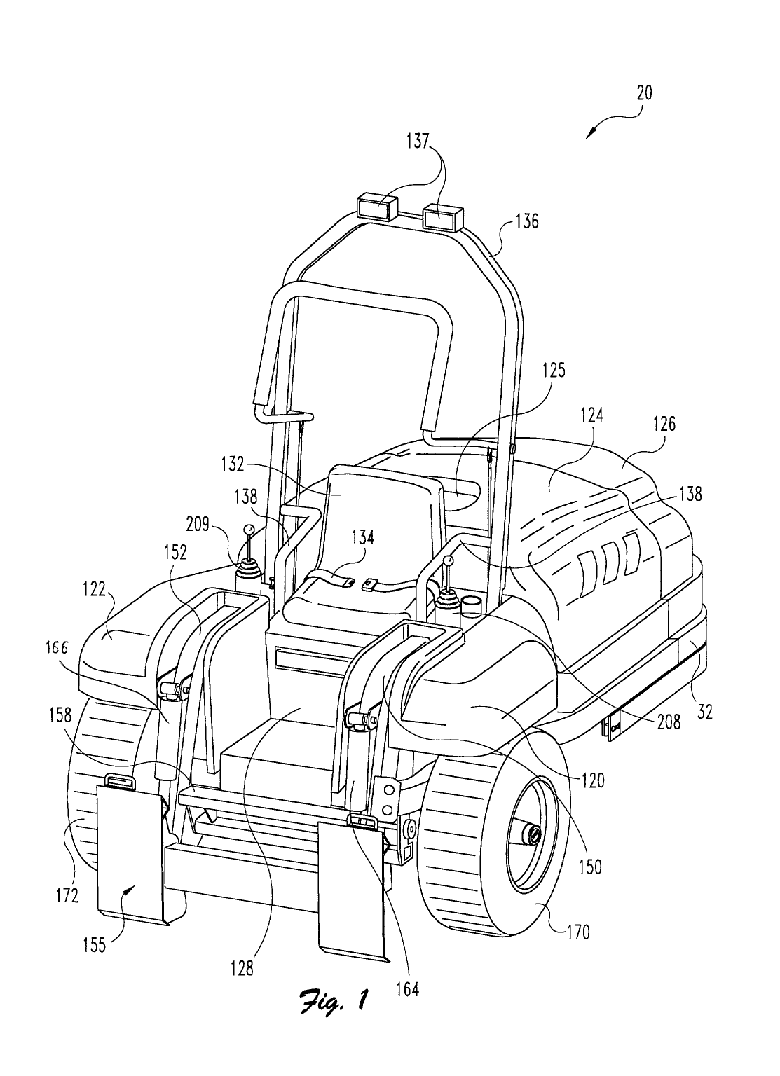

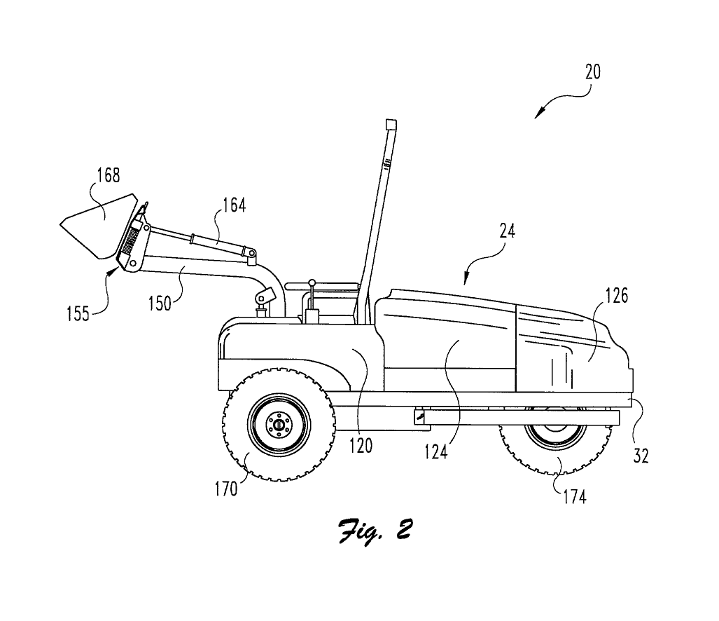

FIGS. 1 and 2 show a work vehicle, generally designated 20, configured according to an exemplary form of the present invention. Work vehicle 20 is designed to be self-propelled around a job site at which a user may operate the vehicle, along with the various materials handling attachments selectively and interchangeably mountable thereto, to perform an assortment of construction tasks. Work vehicle 20 is also configured to be towable over a road at highway speeds behind a truck or other automobile-type vehicle to another job site at which location it can be unhitched from the towing vehicle and self-propelled to perform its intended functions.

Work vehicle 20 includes an assembled body 24 having a forward end at which movable lift arms are positioned, and a rearward end at which a tow assembly is installed. References herein to forward and rearward, as well as right and left, are taken from the perspective of an operator seated on and driving work vehicle 20 around a job site, and therefore, for example, the forward direction would extend to the left from the perspective of a FIG. 2 viewer. In view of this direction convention, when being towed between job sites, work vehicle 20 moves rearwardly.

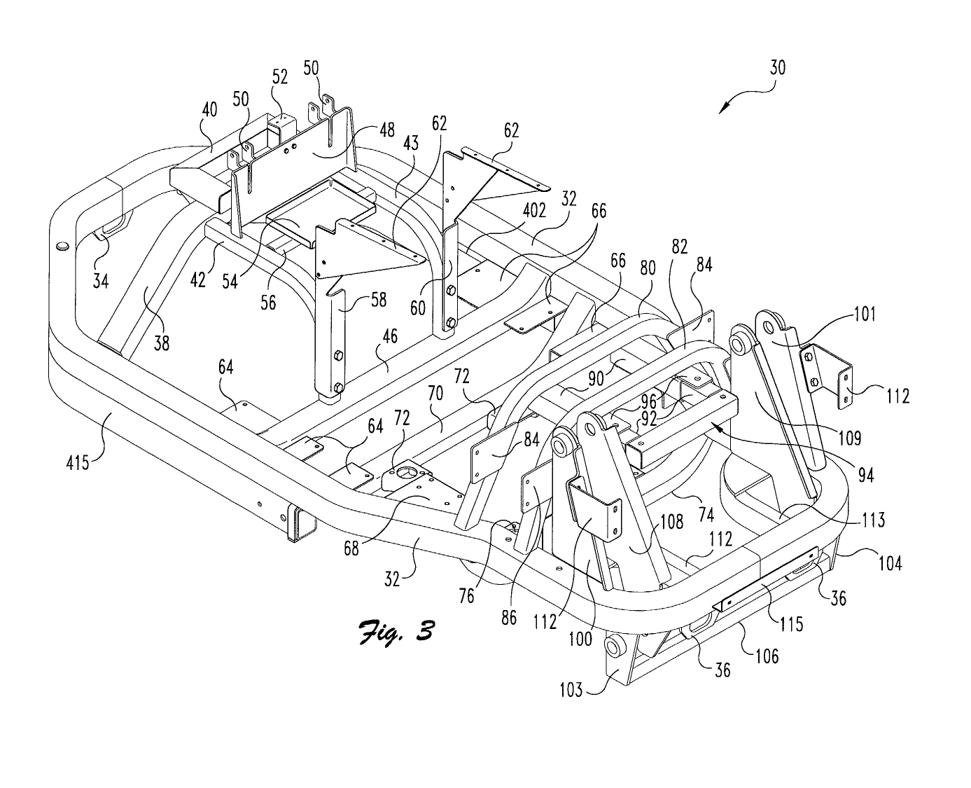

Body 24 includes in the preferred embodiment a multi-piece shroud that mounts to and covers a rigid frame assembly or chassis, generally designated 30, that serves as a base on which are installed other components of the vehicle. A preferred configuration of frame assembly 30 is shown in front perspective view in FIG. 3, and is assembled by fastening or welding together steel component parts. This frame configuration is merely illustrative and not intended to be limiting, as other frame designs may be substituted by one of skill in the art.

Frame assembly 30 is shown including a base member 32 that extends around the entire frame perimeter and is made of welded tubular steel. One tie-down 34 at the rear end of body 24, and a pair of tie-downs 36 at the front of body 24, depend from the underside of base member 32. The tie-downs allow for convenient attachment to frame assembly 30 of ropes or chains used to, for example, extract work vehicle 20 if stuck in the mud at a job site.

A squared arch shaped crossbeam 38 that mounts rear wheel 174 spans the frame width and is attached, such as by welding, at either end to base member 32.

A U-shaped bar assembly 40 that serves as a rearward ballast rack is attached to the top of and rearwardly extends from crossbeam 38. Parallel bowed beams 42, 43 each attach to crossbeam 38 at one end and at the other end to a transverse support 46 that spans base member 32. An upstanding hood hinge support plate 48 is attached to bowed beams 42 and 43. Upwardly extending near the upper ends of plate 48 are two sets of hinge brackets 50 which each receive a pivot pin and which are used to pivotably mount the shroud hood. A rearwardly extending L-shaped plate 52 is fastened to and projects above support plate 48 and includes openings which receive fasteners used to secure the shroud rear cover on the vehicle frame. Flat plate 54 with upturned side edges is mounted on crossbeam 56 that spans bowed beams 42 and 43, and plate 54 supports a not shown battery used in the electrical powering of work vehicle 20.

Uprights 58 and 60 fastened to bowed beams 42 and 43, respectively, each include a forwardly projecting flange section 62 on which mounts a not shown hydraulic oil cooler. Horizontal plates 64 inwardly extending from the inward surface of base member 32 on the right side of frame assembly 30 provide mounts for a hydraulic tank of work vehicle 20, and similar plates 66 on the left side of the frame assembly serve as mounts for the vehicle fuel tank. A pair of plates 68 welded to base member 32 on opposite sides of frame assembly 30 provide attachment points for roll bar 136.

An engine support beam 70 transversely spans base member 32, and a pair of mounts 72 to which the vehicle engine is installed during manufacture are welded to the forward face of support beam 70. An additional support beam 74 forward of beam 70 also transversely spans base member 32 and is provided with a pair of rearwardly extending engine mounts 76.

Crossbeam 80 projects above and spans base member 32 and serves as a support for operator seat 132. Laterally extending flanges 84 which are mounted to crossbeam 80 on either side of frame assembly 30 receive fasteners that mount shroud fender portions 120 and 122. Welded to the underside of the horizontal, upper section of crossbeams 80 is a pair of parallel, square tubes 90 which slidably receive arms 92 of a forward ballast rack, generally designated 94. Apertured locking flanges 96 that each accommodate a pin used in positioning ballast rack 94 project forward of tubes 90 and are welded to tubes 90.

To pivotally support the vehicle lift arms, brackets are provided at the front of frame assembly 30. Generally triangular side brackets 100 and 101 upwardly extend from and are welded to base member 32 on opposite sides of the frame assembly. Plates 103 and 104 are butt-welded to and extend below base member 32 to a horizontally extending crossbeam 106. Brackets 108 and 109 are mounted to beam member 32 by a weld therebetween along the forward edges of the brackets and by supports 112 and 113. The lower ends of brackets 108 and 109 extend down and are welded to crossbeam 106. A not shown pivot pin assembly that extends through aligned, boss surrounded apertures in the upper portions of brackets 100 and 108, and another not shown pivot pin assembly that extends through boss surrounded apertures in the upper portions of brackets 101 and 109, pivotally support the vehicle lift arms on frame assembly 30. In a similar manner, aligned boss surrounded apertures in the lower portion of bracket 108 and plate 103, and bracket 109 and plate 104, receive pin assemblies to install lift arm moving hydraulic cylinders to the frame assembly. Forwardly extending mounts 112 fastened to brackets 100 and 101 provide additional mounting points for shroud fender portions 120 and 122. Lipped plate 115 projects from the forward end of base member 32.

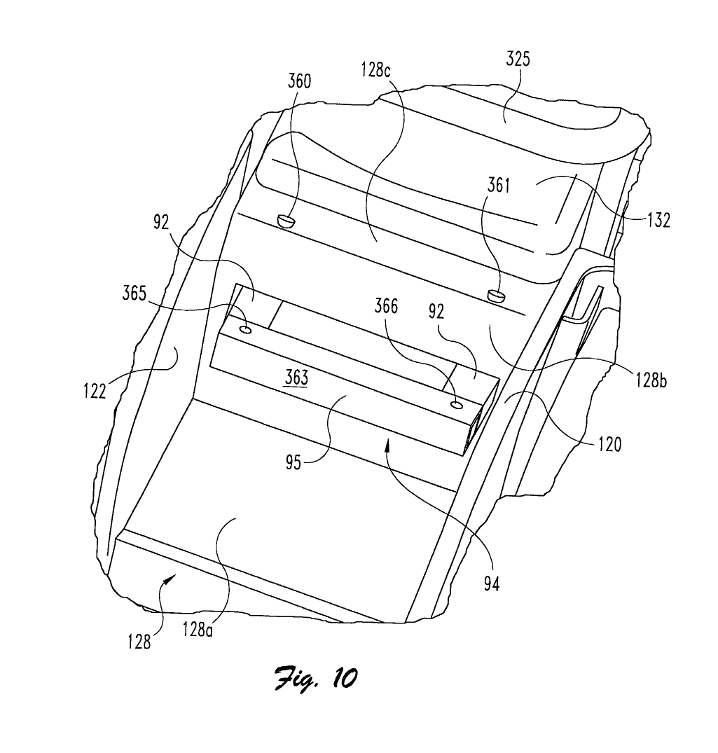

The shroud that mounts to and covers frame assembly 30 is primarily made of a relatively lightweight but durable material, such as molded ABS plastic or fiberglass. The shroud includes left and right fender portions 120 and 122, a hood 124 rearward of the fender portions which is mounted to frame assembly brackets 50 to be pivotable upward to permit ready access to the internal components of work vehicle 20, and a removable rear cover 126 that fits over the back region of frame assembly 30. Hood 124 includes an opening 125 for cooling air to flow through the not shown oil cooler as induced by an electric fan mounted on board the cooler. Between fenders 120 and 122, the shroud includes a rigid steel plate 128, which is the base of an operator station subassembly mounted as a unit to the frame during vehicle manufacture. As best shown in FIG. 10, shroud plate 128 is multi-angled or stepped to form the horizontal floor portion 128a and vertical back portion 128b of a feet and leg accommodating region of the operator's station of work vehicle 20. A depending lip of shroud plate floor portion 128a is fastened to frame plate 115, and a shroud plate section 128c that horizontally and rearwardly extends from the top edge of plate back portion 128b extends underneath seat 132 to reach hood 124. Seat 132, as well as rail guards 138, are attached to plate section 128c. Lateral extensions of plate section 128c, such as separate metal plates rigidly attached thereto, mount joysticks 208 and 209 and control panel 190.

The station or area of vehicle 20 at which the operator controls the vehicle during work operations is equipped with a back-supporting seat 132 with a latching seatbelt 134 for the operator. Roll bar 136 extends above seat 132, and a pair of rail guards 138 attached to roll bar 136 flank seat 132 on either side and aid in locating the operator on the seat at a position between the vehicle controls. Roll bar 136 is equipped with electric work lights 137 connected to the vehicle battery and controlled by switches at control panel 190 for illuminating the work zone. The operator controls include movable joysticks 208 and 209 installed on the sides of the operator station, and control panel 190 to the right of seat 132 includes additional system controls which are readily accessible to a seated operator.

A pair of tubular steel lift arms 150 and 152 that flank the forward portion of the operator station and move in unison are pivotably connected at their upper ends to upstanding brackets 101 and 109, and 100 and 108, respectively. The lower ends of lift arms 150 and 152 are spanned by a quick attach system, generally designated 155, for interchangeably attaching any one of a variety of materials handling attachments or tools, such as a bucket, pallet fork, planer, and grinder, on the work vehicle 20. These additional tools can be transported to a job site in the towing vehicle and can be mounted on work vehicle 20 in place of a current tool when needed.

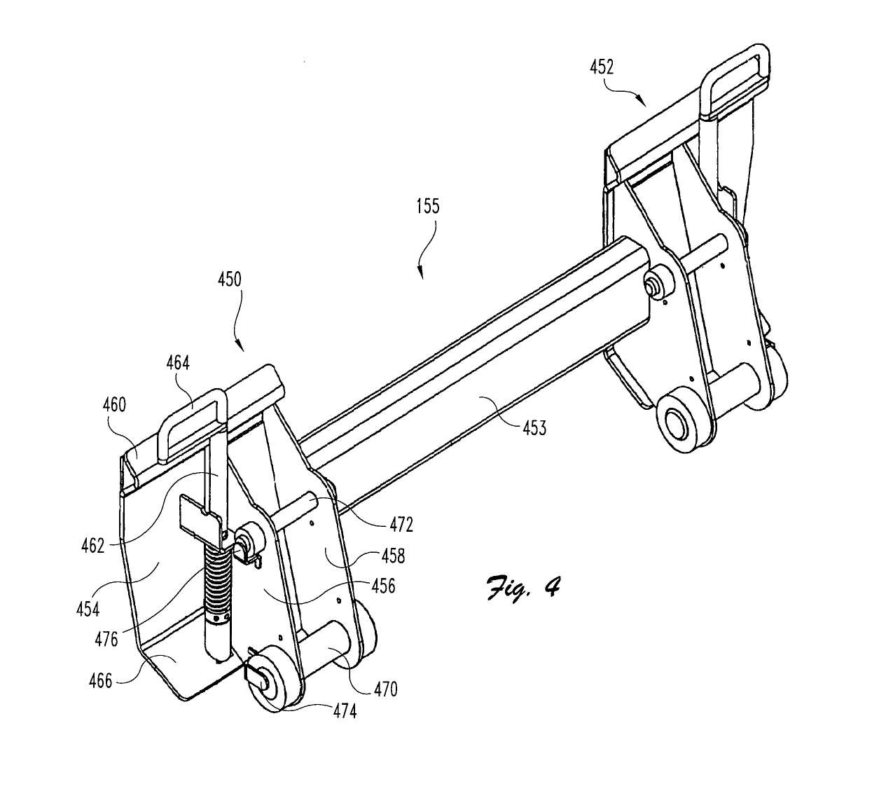

A preferred form of quick attach system 155 is further shown in FIG. 4 in a rear perspective view. Quick attach system 155 is designed complementary to a mounting portion provided on each of the various materials handling attachments to be used with work vehicle 20. Quick attach system 155 includes a pair of mounting modules 450 and 452 spanned by crossmember 453. As mounting modules 450 and 452 are mirror images of each other, the following explanation of module 450 has equal application to module 452.

Module 450 includes an angled plate 454 from which rearwardly extend flanges 456 and 458. Angle bar 460 welded to plate 454 provides a ledge for an overhanging lip of the mounting portion of the attachment. A spring biased locking rod 462 manually retractable by pulling upward on handle 464 is slidably supported on flange 456. The lower end of rod 462 fits through a hole in plate section 466 to insert within an opening in the part of the mounting portion of the attachment which underlies plate section 466 to thereby secure the attachment. Pins 470 and 472 each fit through and extend between boss-lined openings in flanges 456 and 458. Stepped tabs 474 and 476 welded to flange 456 and pins 470 and 472 respectively prevent pin rotation. Lift arm 150 is connected to module 450 at pin 470, and hydraulic cylinder 164 is connected to module 450 at pin 472. While the shown configuration of quick attach system 155 is preferred as it provides a simple yet effective means of attaching to a mounting portion of an attachment becoming standard in the skid-steer industry, other quick attach systems, including the many versions known and widely used in the skid-steer industry, may be employed within the scope of the invention.

Cross brace 158 spans lift arms 150 and 152 and serves as a step for the operator to climb up to seat 132. A pair of hydraulic cylinders 160 and 162 connected between frame assembly 30 and lift arms 150 and 152, respectively, operate together to move lift arms 150 and 152 about their pivot connection between the lowered position shown in FIG. 1 and the raised position shown in FIG. 2. Hydraulic cylinders 164 and 166 mounted on lifts arms 150 and 152, respectively, connect to attachment system 155 and work together to effect system pivoting relative to the lift arms in order to tilt the mounted attachment, such as to tilt and thereby unload bucket 168.

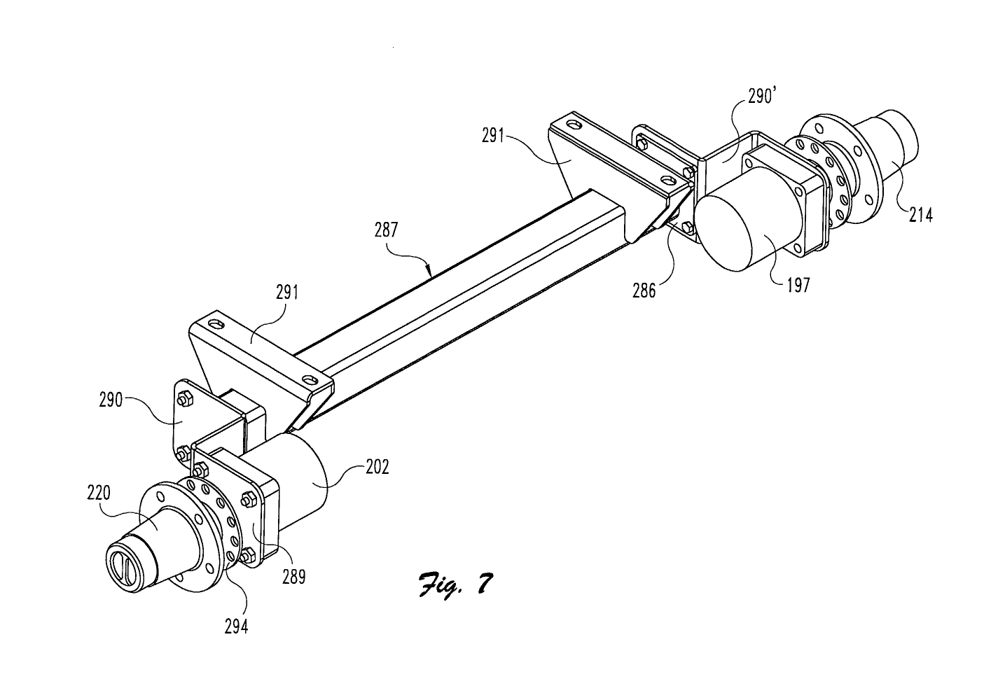

In the preferred embodiment, work vehicle 20 rolls over the ground on three ground-engaging wheels, which are preferably rim-mounted pneumatic tires. Drive wheels 170 and 172 are located on opposite sides of body 24 with each wheel axis of rotation at a location slightly forward of operator seat 132. To facilitate vehicle manufacture, drive wheels 170 and 172 are journaled on opposite ends of a motor-supporting axle subassembly shown in FIG. 7, which subassembly is fastened as a unit to the underside of base member 32 of frame assembly 30 during vehicle manufacture. A free-wheeling rear wheel 174 is suspended from frame crossbeam 38 at a location along the longitudinally extending centerline of the vehicle. Rear wheel 174 is a caster that swivels 360° about a vertical axis relative to body 24, and which freely rotates about a horizontal axis as it engages the ground during work operations.

Although only two drive wheels situated forward on body 24 are used in the preferred embodiment, the location and number of such wheels may be altered within the scope of the present invention. For example, although lateral stability during lifting would be lessened, the longitudinal positions of the pair of drive wheels and the caster may be reversed. Still further, the single caster may be replaced by a pair of laterally spaced casters, or by a pair of wheels mounted on the opposite ends of a common axle. Still further, the vehicle may be equipped with steerable all-wheel drive, in either a three wheel or four wheel arrangement.

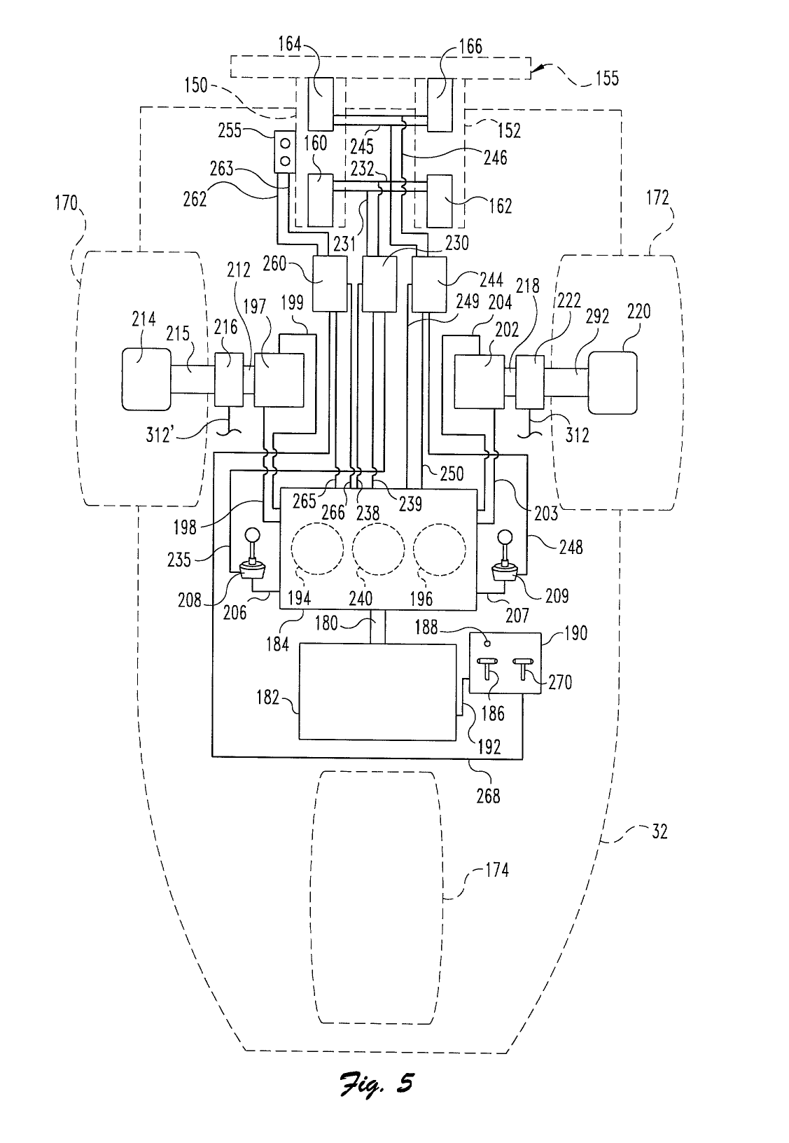

Drive wheels 170 and 172 are preferably independently motorized or powerable to move work vehicle 20 in a skid steer fashion in the self-propelled, operational mode. Other drive systems using a different number of motors or a different power transmission and control system may alternatively be employed. The primary components of a preferred system used to power and control the drive wheels, as well as work operations using an attached materials handling attachment, are shown in schematic form in FIG. 5. The positioning of the motors, pumps, valves and other parts in FIG. 5 is not necessarily representative of where such parts are positioned relative to frame assembly 30, but rather are so positioned to facilitate illustration of the interconnections of the shown components.

The output shaft 180 of an internal combustion engine 182 drives a hydraulic pumping assembly indicated at 184. Engine 182 runs on gasoline or diesel fuel which is supplied from a not shown fuel tank mounted to frame assembly 30 rearwardly of seat 132 on mounts 66. Standard controls for engine 182, such as a throttle 186 and choke 188, are located on control panel 190 and connected to engine 182 as indicated at line 192.

Hydraulic pumping assembly 184 includes reversible, tandem hydrostatic pumps indicated in dashed lines at 194 and 196. For the plumbing abstractly shown in FIG. 5, hydraulic pumping assembly 184 also represents a storage tank of hydraulic fluid for the system, which tank in the preferred embodiment is mounted to frame assembly 30 on mounts 64. Hydraulic pumping assembly 184 is directly hydraulically coupled to left drive motor 197 via lines 198 and 199 such that pump 194 powers that motor. Hydraulic pumping assembly 184 is directly hydraulically coupled to right drive motor 202 via lines 203 and 204 such that pump 196 powers the right drive motor. This separate coupling of the pumps to the left and right drive motors allows independent control of the left and right drive wheels. Pumps 194 and 196 are respectively connected by cables 206 and 207 to joystick controls 208 and 209 designed to move along two axes of motion. Movement of joystick control 208 by the operator along one axis of motion in the fore and aft directions controls the output displacement and flow direction of pump 194 to thereby control the direction and speed of motor 197, and joystick control 209 similarly is used to control pump 196 and therefore motor 202.

The output shaft 212 of left motor 197 is operably connected to hub 214 of left wheel 170 via a coupler 215. The inward end of coupler 215 is pinned to motor shaft 212 so as to rotate therewith, and hub 214 is fixed to the outward end of the coupler. A brake assembly indicated at 216 that selectively prevents rotation of motor shaft 212 is further described below. Hub 214 is a lockout hub that can be manipulated by an operator to operably disconnect and reconnect drive wheel 170 with the rotatable motor shaft 212. One suitable type of lockout hub is available as p/n 9790 and 36317 from Warn Industries of Clackamas, Oreg. Other types of lockout hubs may be employed within the scope of the present invention. When lockout hub 214 is manually rotated by a user to operably disconnect wheel 170 from motor shaft 212, wheel 170 is placed into a free-wheeling mode for towing in which rotation of motor shaft 212 does not turn wheel 170 and wheel 170 is free to rotate independently of coupler 215 and motor shaft 212 of the propulsion system. When lockout hub 214 is turned by a user to operably reconnect wheel 170 to motor shaft 212, wheel 170 is placed into an operational mode in which it rotates with and is driven by motor shaft 212. In a similar manner, output shaft 218 of right drive motor 202 is directly connected by coupler 292 to a lockout hub 220 of right wheel 172, and brake assembly 222 is provided for braking motor shaft 218.

The mechanisms used to power operation of the lift arms, and operation of certain types of powered materials handling attachments used therewith, are preferably hydraulic. In the shown embodiment, hydraulic cylinders 160 and 162 used to raise and lower the lift arms 150, 152 are connected to valve 230 by lines 231 and 232 feeding opposite ends of the cylinders. Valve 230 is a bidirectional, manual spool valve which is actuated by cable 235 controlled by the operator by side to side motion of left joystick control 208. Valve 230 is plumbed to hydraulic pumping assembly 184 by lines 238 and 239 which are routed to the storage tank and a nonreversible hydrostatic pump 240 of hydraulic pumping assembly 184. Hydraulic cylinders 164 and 166 on lift arms 150, 152 and which effect a pitch of a lift arm mounted work implement are connected to valve 244 by lines 245 and 246 feeding opposite ends of the cylinders. Valve 244 is also a bidirectional, manual spool valve but is actuated by cable 248 independently controlled by side to side motion of right joystick control 209, and is connected with the hydraulic fluid storage tank and hydrostatic pump 240 by lines 249 and 250.

In order to provide a source of hydraulic power needed for operation by some attachments such as augers or planers, an auxiliary hydraulic supply circuit is provided on work vehicle 20. A fitting 255 provided on lift arm 150 is connected to valve 260 by lines 262 and 263. Fitting 255 includes receptacles for connection with hydraulic conduits leading to the attachment. Valve 260 is plumbed to hydraulic pumping assembly 184 by lines 265 and 266. Valve 260 is a bidirectional, manual spool valve actuated by cable 268 connected with lever 270 on control panel 190. Although valves 230, 244 and 260 are shown as separate elements in FIG. 5, in a preferred embodiment such are different working portions of a three-spool monoblock valve. Lever 270 includes neutral, forward and aft positions in order for the operator to control the direction and amount of flow of hydraulic fluid to fitting 255.

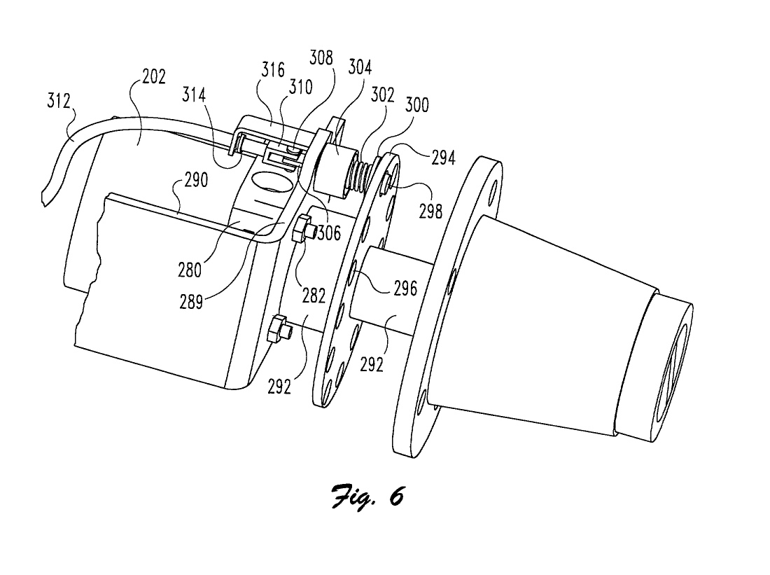

In the preferred embodiment, the vehicle power trains equipped with brake assemblies 216 and 222, and lockout hubs 214 and 220, provide part of a means for preventing propulsion of the drive wheels when the operator seat is not properly occupied, which means permit the drive wheels to be placed in free-wheeling mode for ground-engaging contact during towing of the vehicle between job sites with the operator seat unoccupied. Referring now to FIG. 6, a preferred configuration of a braking assembly of such means is shown in perspective view. While FIG. 6 illustrates parts associated with right drive wheel 172, corresponding parts for left drive wheel 170 are a mirror image thereof, and therefore the following description has equal application thereto.

Flange 280 of hydraulic motor 202 is mounted, such as with fasteners represented at 282, to an outward leg 289 of a stepped support plate 290 that forms an outward end of an axle subassembly. The axle subassembly is further shown in FIG. 7, in which portions of the wheel and wheel braking systems other than the brake discs described below are not shown to facilitate illustration. Stepped support plate 290, which includes a not shown triangular gusset over the motor, is fixedly secured, such as with bolts, to a not shown mounting plate welded to a not shown inner beam that extends within an outer tube of axle tube assembly 287 and to a similar mounting plate 286 secured to a stepped support plate 290′ for left wheel mounting. Axle tube assembly 287 transversely spans the width of vehicle frame 30 and includes elastomeric members between its inner beam and outer tube to resist torsion and for suspension purposes. One suitable axle tube assembly is known as a dura-flex torsion tube assembly from Henschen Industrial of Jackson Center, Ohio. At either end, axle tube assembly 287 includes a bracket 291 that mounts to a plate fixed to the underside of frame base member 32 with fasteners, such as bolts.

Output shaft 218 of motor 202 extends through an opening in support plate leg 289, and shaft 218 is fixed by a pin to coupler 292 and used to power wheel rotation. Lockout hub 220 is mounted to the end of coupler 292, and is adapted to selectively disconnect and reconnect wheel 172 from rotation with coupler 292 and therefore shaft 218. Fixed to coupler 292 to rotate therewith is a disc-shaped brake plate 294 made of steel or other rigid material. This fixed attachment is obtained by forming plate 294 with a central opening that fits onto a keyed exterior of the coupler. A multitude of angularly spaced, circular openings 296 extend through brake disc 294. Although twelve openings are equally spaced circumferentially in the shown embodiment, fewer or additional openings may be employed within the scope of the invention. Each of openings 296 is sized and radially positioned such that when disc 294 is rotated such that any given opening is located at the top, that opening is arranged to receive therethrough a spring-biased lock pin 298 as shown in FIG. 6. When lock pin 298 is in the locked position shown in FIG. 6 in engagement with disc 294 by its extension through opening 296, the rotation of motor shaft 218 is prevented, thereby preventing a motor-powered rotation of wheel 172.

Lock pin 298 is installed through spring-retaining washer 300, coiled compression spring 302, bushing 304, and an upstanding lobe of support plate leg 289. A flat extension 306 of the inward end of lock pin 298 receives a clevis pin 308 that extends through yoke 310. Washer 300 is fixed to lock pin 298 to move axially therewith. Opposite ends of compression spring 302 abut support plate leg 289 and washer 300 so spring 302 biases lock pin 298 outward toward engagement with brake disc 294. Bushing 304 is made of an elastomeric material and serves to protect the surrounded spring 302.

The cable within the protective sheath of sheathed cable 312 attaches to yoke 310. Retention clip 314 is secured to the sheath of sheathed cable 312, and an L-shaped fork member 316 fixed to support plate leg 289 holds clip 314 to allow the internal cable of the sheathed cable 312 connected to yoke 310 to move relative to the sheath during operation of the braking system. Another not shown retention clip which is secured to the sheath of sheathed cable 312 and axially retained on plate section 128c proximate seat 132 also holds the sheath to allow the internal cable to be moved.

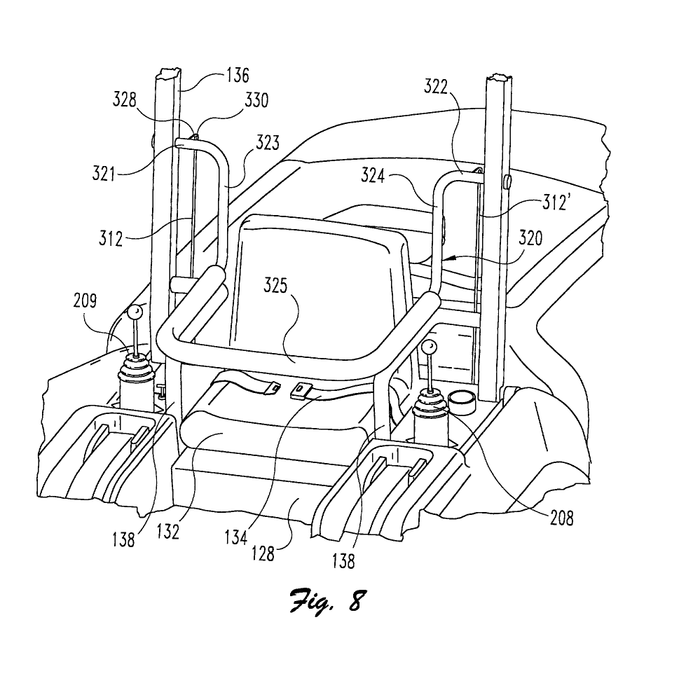

The motor braking system functions responsive to movement of an operator restraint or rigid belly bar, generally indicated at 320, over vehicle seat 132. Operator restraint bar 320 is made of steel and includes end sections 321 and 322, middle sections 323 and 324, and restraint section 325. End sections 321 and 322 are journaled to roll bar 136 fixed to frame assembly 30. Middle sections 323 and 324 extend orthogonally from end sections 321 and 322 and bend into restraint section 325, which has a square U-shaped configuration and which is encased in padding for operator comfort. When oriented as shown in FIG. 8, restraint section 325 of belly bar 320 spans the space in front of an operator seated in seat 132 and fits over her lap, thereby preventing her ready egress from the seat. The bar 320 is preferably maintained in this orientation by gravity. Torsion springs can be provided between the end sections 321, 322 to restrict the downward position of the restraint section 325. The end of sheathed cable 312 opposite the end attached to yoke 310 includes an eyelet 328 of the internal cable which is attached to crank 330 fixedly extending from end section 321. Sheathed cable 312′ attached to a similar crank on bar end section 322 extends to the drive motor braking system for left wheel 170. Cranks 330 are designed such that when belly bar 320 is in the lowered position shown in FIG. 8, sheathed cables 312 and 312′ have been pulled upward such that the lock pins 298 of the right and left drive motor braking systems to which such cables are attached are each withdrawn from a disc opening 296 against the biasing force of a retained spring 302, thereby releasing brake disc 294 to allow motor shaft rotation. When operator restraint bar 320 is pivoted upward by an operator to the raised arrangement shown in FIG. 1, cranks 330 rotate downward to lower cables 312 and 312′, which lowering allows a biasing spring 302 of each drive motor braking system to force a lock pin 298 back into one of the apertures 296 to engage a brake disc 294 and thereby lock both motor output shafts from further motion. When in the retracted orientation shown in FIG. 1, operator restraint bar 320 poses no obstacle to the operator entering and exiting seat 132. While the shown motor braking system is preferred, other braking mechanisms may be substituted within the scope of the invention. For example, belly bar 320 can be connected to a micro-switch which allows engine 182 to be powered when the bar is lowered as shown in FIG. 8, but which cuts off power to engine 182 when the bar is raised.

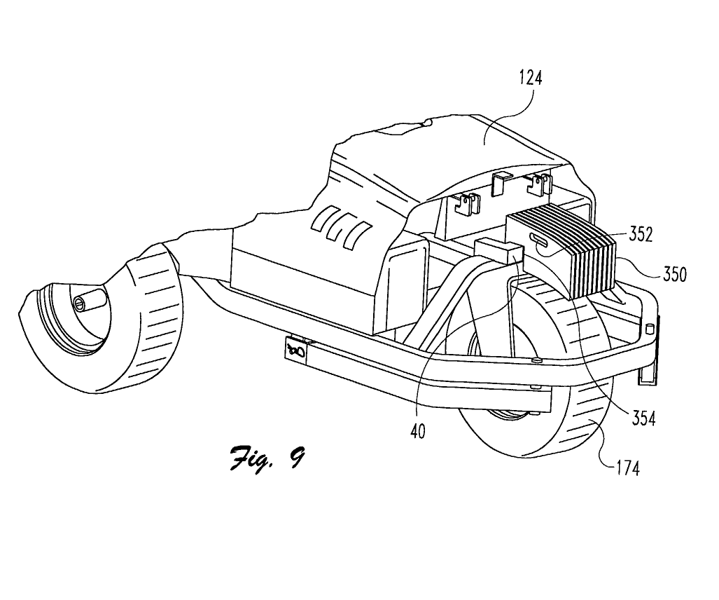

In the preferred embodiment, work vehicle 20 also includes a means for redistributing weight on body 24 to adapt work vehicle 20 for either towing or work operations. As shown in FIG. 9, in which rear cover 126 has been removed for purposes of illustration, relocatable ballast of work vehicle 20 is provided in the form of manually movable weights. The movable weights are generally rectangular ballast plates 350 made of a heavy material, such as steel. One suitable form of ballast plate 350 is made of plate steel in a size weighing 30 pounds, and preferably ten of such plates are provided. Fewer or additional plates, as well as lighter or heavier plates, may be provided so long as satisfactory counterweight capabilities are achieved.

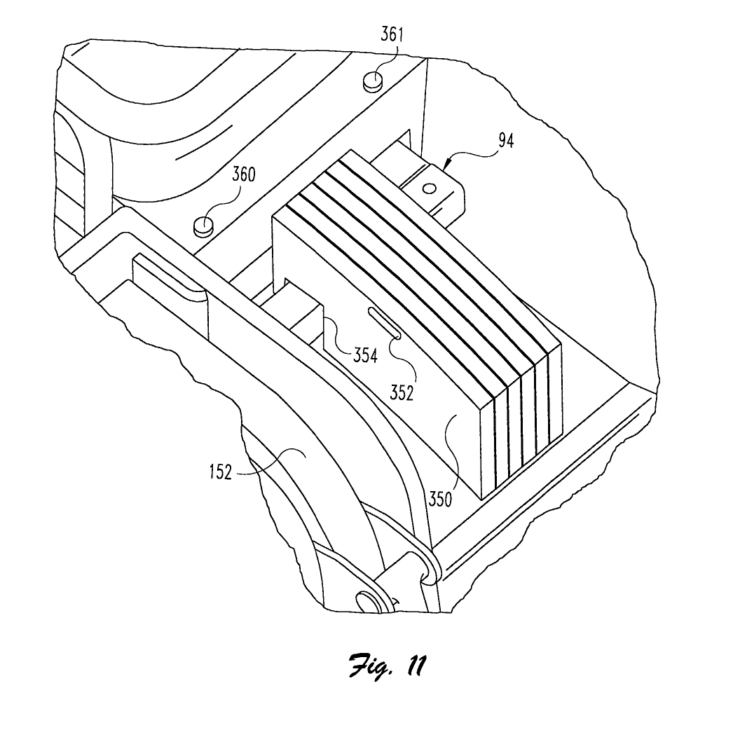

With additional reference to FIGS. 10 and 11, each ballast plate 350 includes a hole 352 through an upper region which serves as a grip through which an operator can fit his/her fingers when he/she manually lifts and then carries the ballast plate forward during vehicle weight modifications as further described herein. Each ballast plate 350 includes an upstanding, square notch 354 formed into its bottom edge. Notch 354 is offset along the length of the plate so that when mounted to rack 40, the center of gravity of plate 350 acts downward at a location rearward of rack 40. Notch 354 on each plate 350 is sized to closely fit over the square cross-sectional shape of rack 40 which is assembled from tubular steel. While shown as a bar on which fit the ballast plates 350, rack 40, as well as rack 94, can be implemented in other forms, including a cradle into which one or more weights, including differently sized or shaped weights, can be placed.

In FIG. 9, ballast plates 350 are being stored near the rear of work vehicle 20, thereby serving as a counterweight such that when larger loads are being raised on materials handling attachment 168 operably mounted on lift arms 150 and 152, the ballast aids in preventing work vehicle 20 from pitching forward about front drive wheels 170 and 172. Although shown as positioned essentially over rear wheel 174, rack 40 can be positioned at other locations rearward of front wheels 170 and 172. It will be appreciated that the farther back ballast plates 350 are positioned on work vehicle 20, the less actual weight is necessary to achieve a given resistance to forward tipping during operations.

When work vehicle 20 is to be towed, ballast plates 350 may be relocated to a forward location on work vehicle 20. A forward relocation reduces the weight acting on the rear tow assembly, and therefore the towing vehicle, when work vehicle 20 rolls with front wheels 170 and 172 in contact with the highway. In the preferred form shown in FIG. 10, the vehicle operator station is equipped with rack 94 for storing ballast plates 350 during towing, which storage position of the plates is above the front wheels 170 and 172 in the preferred embodiment. Forward rack 94 is formed of a U-shaped steel assembly similar to rearward rack 40, and includes a cross member 95 from which rearwardly extend rigid support arms 92 slidably received within sleeves 90 shown in FIG. 3. In FIG. 10, forward rack 94 is arranged in an extended, ballast receiving position. Locking pins 360 and 361 extend downwardly through openings in shroud plate section 128c, through apertured flanges 96, and insert within holes in support arms 92 to prevent further forward or rearward movement of rack 94. When forward rack 94 is locked in the position shown in FIG. 10, one or more of the ballast plates 350 on rearward rack 40 can be lifted off by an operator, carried forward, and placed on forward rack 94 in the arrangement shown in FIG. 11. The number of ballast plates 350 moved forward depends upon the size of the towing vehicle, as smaller vehicles may require most if not all of plates 350 to be moved to forward rack 94. Upon reaching a job site, ballast plates 350 are taken from rack 94 and moved to rearward rack 40, pins 360 and 361 are then withdrawn, and forward rack 94 is pushed rearwardly such that the forward face 363 of cross member 95 rests nearly flush with shroud plate section 128b. When so arranged, pins 360 and 361 can be reinserted downward through plate section 128c and flanges 96 to fit into holes 365 and 366 in cross member 95 to secure forward rack 94 in a stored position, which stored position is recessed in the operator station to not interfere with the operator during use of work vehicle 20.

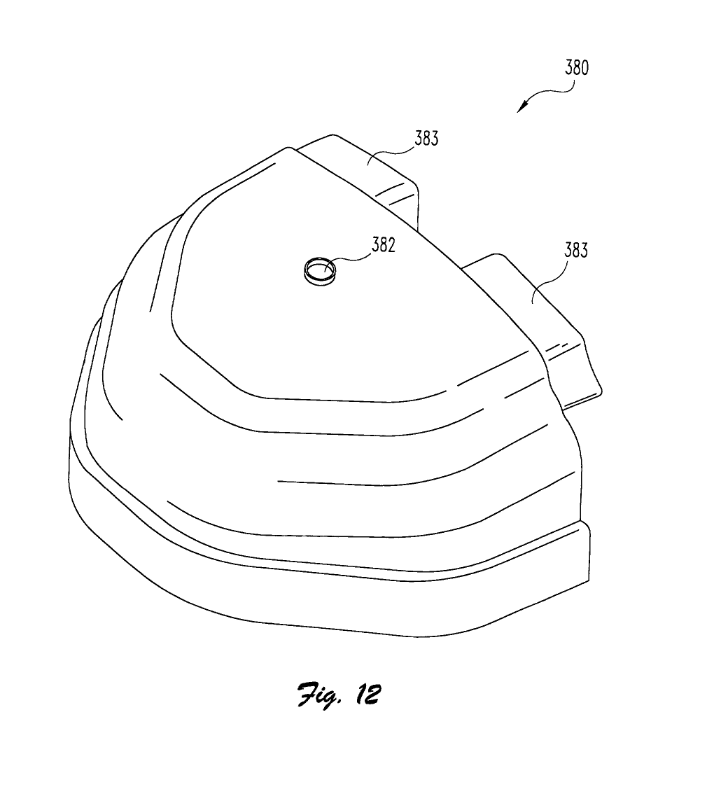

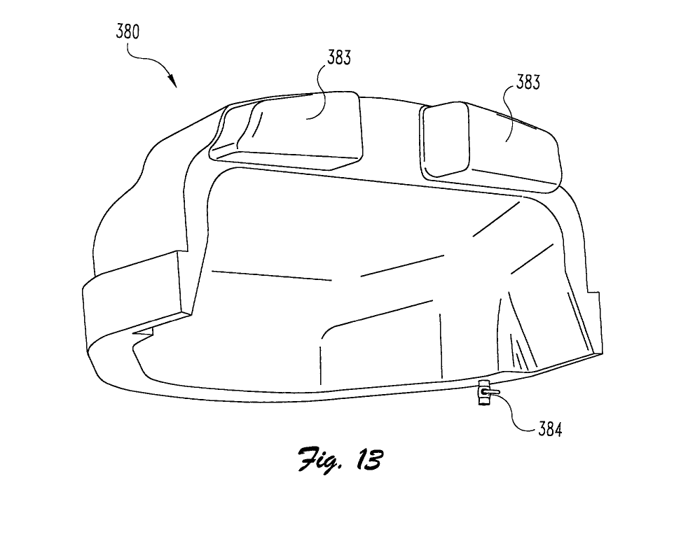

In an alternate ballast system for a work vehicle of the present invention, the relocatable ballast plates 350 and associated racks are replaced with a fluid fillable ballast tank. In one form of such system, shroud rear cover 126 is replaced with a molded tank 380 shown in FIGS. 12 and 13. Tank 380, which has a rear periphery shaped similar to cover 126, includes forwardly protruding portions 383 that fit below hood 124 when installed and flank the vehicle battery mounted on plate 54. Tank 380 is a rotomolded tank made of ABS plastic and is mechanically attached to frame assembly 30, such as from below with screws and to bracket 52 at the top of the tank. Tank 380, including protrusions 383, has a hollow interior volume into which fluid can be introduced through an inlet opening in the top wall of the tank. Cap 382 covers the inlet opening and is manually openable by an operator to allow tank access. The tank interior volume can be drained by gravity through an outlet in the bottom of tank 380 equipped with a closable valve or stopcock 384, or a plug. Valve 384 can be opened and closed by an operator to control draining of fluid from the bottom of the tank. In practice, when work vehicle 20 is to be towed, tank 380 is empty so as to minimize the weight being pulled by the towing vehicle. Upon reaching a job site, fluid such as water which is available at the site is poured into the upcapped inlet opening with valve 384 closed so as to fill up tank 380. After capping, the filled tank, which has a capacity of about thirty-four gallons so as to weigh about two hundred eighty-six pounds when filled with water, then serves as a counterweight to resist forward tipping of work vehicle 20 during lift arm raising. When work at the job site is completed and work vehicle 20 is to be towed, valve 384 is twisted open by the operator to allow fluid in tank 380 to drain to the ground to lighten the vehicle for towing.

In still further alternate embodiments, the relocation of the ballast on work vehicle 20 may be achieved in different fashions. For example, the ballast can be provided as a weight attached to a carriage which is slidably movable on the frame assembly between first and second longitudinal positions on the work vehicle, which longitudinal positional changes can be effected through the use of one or more hydraulic cylinders. The ballast alternatively may be provided as fluid which can be selectively pumped between first and second tanks respectively located at forward and rearward portions of the vehicle, the forward tank being filled with water pumped from the rear tank when the vehicle is to be towed between job sites, and the rearward tank being filled with water pumped from the forward tank for counterweight purposes when the vehicle is operated on a job site.

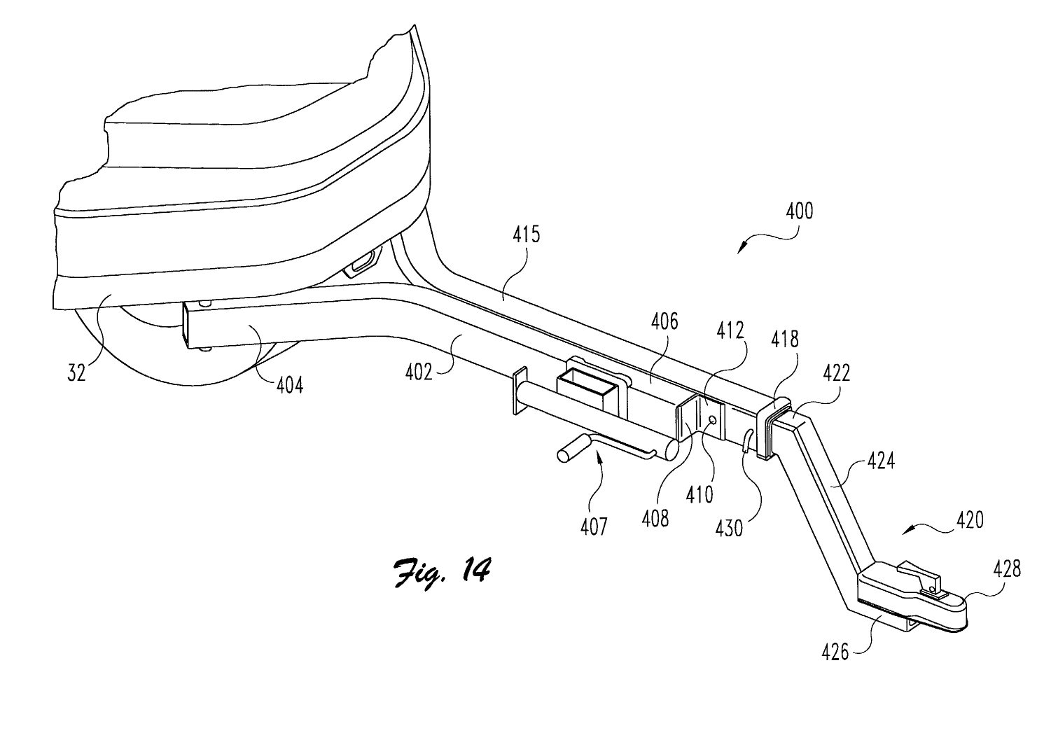

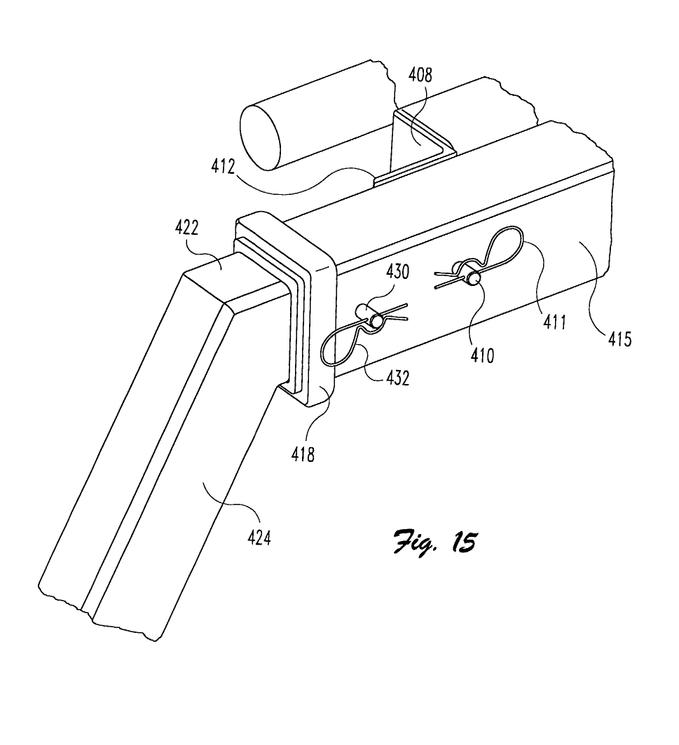

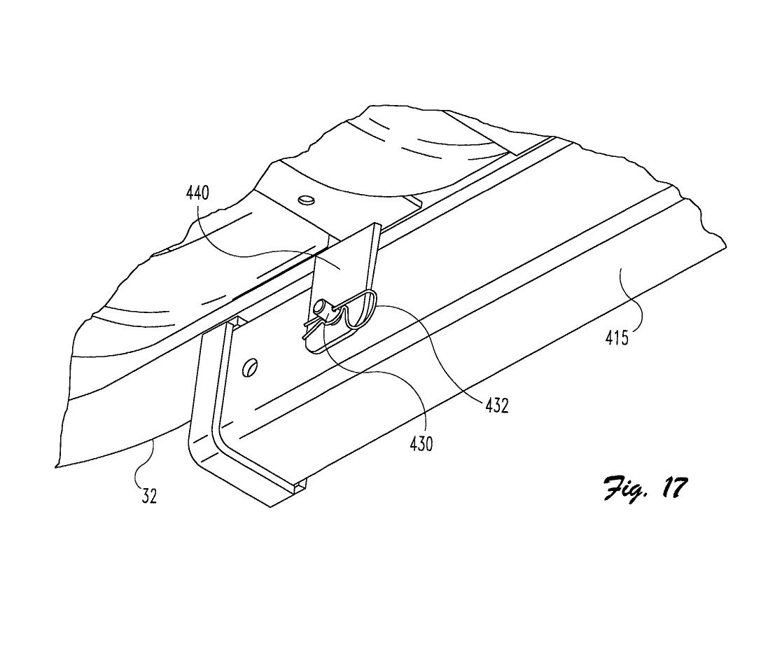

Work vehicle 20 is also equipped with means for attaching to a towing vehicle used to pull a free-wheeling work vehicle 20 between job sites. In the preferred embodiment shown in FIGS. 14-17, the tow assembly is designed to extend rearwardly when needed for towing, and to pivot forwardly to a storage location under frame assembly 30 when work vehicle 20 is self-propelling about a job site. The tow assembly, generally designated 400, includes a first angled tow bar 402 formed of tubular steel having a square cross-sectional shape. At one end 404, tow bar 402 is pivotably connected to the underside of frame base member 32 by a vertically extending bolt attachment. The free end 406 of tow bar 402 is capped by angled plate 408. A removable pin 410, which is locked with a transverse cotter pin 411, extends through an opening in flange 412 of angled plate 408 and aligned holes through a second angled tow bar 415 to connect together angled tow bars 402 and 415.

Near end 406, a jack indicated at 407 is mounted on tow bar 402. Shown in the figures in a storage position, jack 407 can be rotated 90° to a use position and operated to jack the tow arm up from the ground. A jack of this type is known as a 6800A swivel jack available from Dutton-Lainson Company of Hastings, Nebr.

In a manner similar to the mounting of tow bar 402, tow bar 415 is pivotably connected to frame base member 32 on the longitudinal side of frame assembly 30 opposite the side on which tow bar 402 is pivotally connected to base member 32. At its free end ringed by steel strip 418 for reinforcement, tow bar 415 is hollow to telescopically receive a detachable hitch extension indicated at 420. Hitch extension 420 includes a proximal end 422 that slidably fits within the free end of tow bar 415, a downwardly angled drop bar portion 424, and a distal end 426 equipped with a releasable hitch 428 that fits over a complementary ball member of a hitch assembly mounted in a conventional fashion on the towing vehicle. When attached to the towing vehicle, drop bar portion 424 causes the rear end of work vehicle 20 to be pivoted upward about front wheels 170 and 172 relative to the towing vehicle such that rear wheel 174 is out of contact with the ground. Depending on the size and type of towing vehicle being used, the height drop may not be required in which case the drop bar portion 424 may be eliminated and the hitch extension may be straight. In an alternate embodiment, and provided sufficient clearance space is available under the vehicle, the features of hitch extension 420 could be integrated into the tow bars. Transverse connecting pin 430 extends through aligned openings in tow bar 415 and proximal end 422 to secure hitch extension 420 to tow arm 415. Cotter pin 432 on the inserted end of connecting pin 430 prevents inadvertent pin withdrawal.

Although not shown in the figures, in order to provide highway signals on the vehicle, a light harness can be provided on tow assembly 400, which harness is connectable to a suitable light package provided on the towing vehicle. The harness is connected to not shown lights provided, for example, on fender portions 120 and 122, which lights would serve as taillights on the vehicle and which lights would preferably be powered by the towing vehicle.

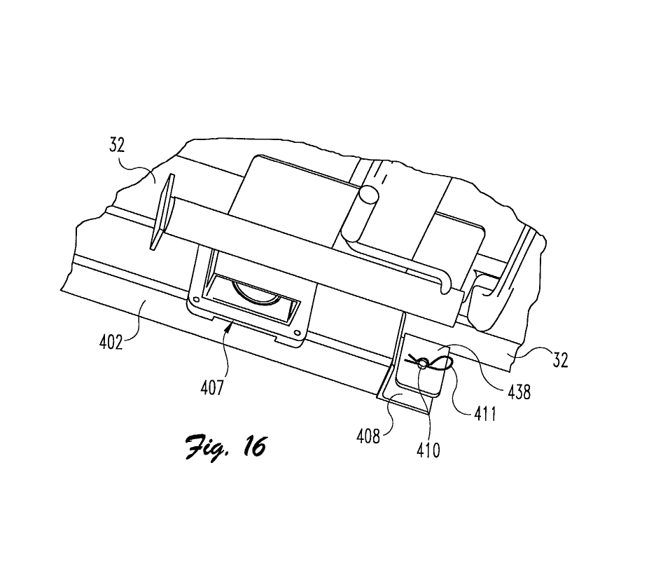

In FIG. 14, tow assembly 400 is shown arranged for work vehicle towing. When not in use, hitch extension 420 is removed by removing pin 432 and withdrawing connecting pin 430, pulling proximal end 422 clear from tow bar 415, and then storing hitch extension 420, such as in the towing vehicle or elsewhere on the job site. After withdrawal of cotter pin 411 and pin 410, tow arms 402 and 415 can each be swept in a generally horizontal plane outwardly away from each other and forward about their respective pivotal connections with frame assembly 30 to positions under frame assembly 30. This pivoting of the tow arms need not be exactly horizontal due to the fact that, for example, frame member 32 can be slightly angled upward at the point of pivotal connection with the tow arms. After being swept forward, tow arms 402 and 415 are each locked in a position underneath work vehicle 20 and out of the way of operations, such as the position shown in FIG. 3 in which the tow arms are aligned below beam member 32. In a preferred locking system, a plate-shaped ear 438 shown in FIG. 16 is welded to the underside of base member 32. Ear 438 receives pin 410 which extends through angled plate 408 and is locked with pin 411. When so pinned, tow arm 402 is prevented from inadvertently swinging outward during work vehicle operation. In a similar fashion, lock ear 440 welded to the side of base member 32 on the right side of frame assembly 30 receives the pin 430 used to attach the hitch extension, which pin is locked with cross pin 432. Although two connectable tow arms are preferred, in an alternate embodiment, a single pivotable arm which fits under the vehicle can be substituted for tow arms 402 and 415, but such may be more cumbersome to swing between towing and storing locations.

Still further, in alternate embodiments of the present invention, other tow assemblies with hitch apparatuses may be substituted for the preferred assembly shown in FIGS. 14-17. For example, a tow bar with hitch that detachably mounts directly to the frame for towing, but which is removable at the job site, may be used. Still further, a telescoping tow bar may be employed. In addition, a simple, dedicated tow bar with hitch that always rearwardly extends from and is fixed to the frame assembly may be used.

While this invention has been shown and described as having multiple designs, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A work vehicle comprising:
a body having a forward end, a rearward end and a length extending between said forward end and said rearward end, said body including an operator station;
at least one lift arm assembly mounted to said body to be movable between a raised position and a lowered position;
an attachment assembly for said at least one lift arm assembly to which any one of a plurality of different complementarily configured materials handling attachments is interchangeably attachable;
a tow element at said body rearward end for connection to an automobile-type towing vehicle behind which the work vehicle is towable between job sites directly on a road at highway speed; and
ground engaging means at first and second locations along said body length, said ground engaging means at said first location including first and second ground engaging drive wheels respectively disposed on opposite sides of the body and convertible between a self-propelling mode and a free-wheeling mode, said first and second ground engaging drive wheels when in said self-propelling mode being operably connected to at least one work vehicle motor and controllable by an operator in said operator station to self-propel the work vehicle around a job site, said first and second ground-engaging drive wheels when in said free-wheeling mode being in direct engagement with the road during towing.

2. The work vehicle of claim 1 wherein said plurality of different materials handling attachments includes a bucket.

3. The work vehicle of claim 2 further comprising means for hydraulically powering the materials handling attachment attached to said at least one lift arm assembly, and wherein the attached materials handling attachment comprises a planer connectable to said powering means.

4. The work vehicle of claim 1 wherein said tow element comprises at least one tow arm including a pivot connection to said body, said at least one tow arm swingable in a generally horizontal plane about said pivot connection between a retracted position and a towing position, and a hitch member mounted on said at least one tow arm and connectable to a complementary hitch element on the towing vehicle.

5. The work vehicle of claim 1 further comprising a first rack member, a second rack member, and a plurality of weights, said first rack member located on said body rearward of at least one of said first location and said second location, said second rack member located on said body forward of said first rack member, said plurality of weights adapted to be loaded on either of said first rack member and said second rack member, said plurality of weights selectively movable between said first and second rack members to adjust a weight distribution of the work vehicle, wherein said plurality of weights when loaded on said first rack member serves as a counterweight to said materials handling attachment during self-propelling of the work vehicle, and wherein said plurality or weights when loaded on said second rack member serve to limit weight acting down on said tow element during towing.

6. A towing apparatus for a work vehicle self-propellable at a job site and towable between job sites directly on a road at highway speeds behind an automobile-type towing vehicle, the work vehicle including at least two road engaging drive wheels convertible between a self-propelling mode and a free-wheeling mode, wherein when in a self-propelling mode the drive wheels are operably connected to at least one work vehicle motor to be driven in a manner controlled by an operator on the work vehicle, and wherein when in a free-wheeling mode the drive wheels are operably disconnected from the at least one work vehicle motor to rotate independently thereof and in direct engagement with the road during towing, said towing apparatus comprising:
at least one tow arm including a pivot connection to the work vehicle, said at least one tow arm swingable in a generally horizontal plane about said pivot connection between a retracted position and a towing position; and
a hitch member on said at least one tow arm and connectable to a complementary hitch element on the towing vehicle.

7. The towing apparatus of claim 6 wherein said at least one tow arm when in said retracted position fits under an outer periphery of the work vehicle to limit interfering with work operations.

8. The towing apparatus of claim 6 wherein said at least one tow arm comprises first and second tow arms pivotally connected to a frame of the work vehicle on opposite sides of a longitudinal centerline of the work vehicle, and further comprising a connector for connecting together said first tow arm and said second tow arm when each is arranged in said towing position.

9. The towing apparatus of claim 6 further comprising a jack mounted to said first tow arm, and wherein said hitch member is on said second tow arm.

10. The towing apparatus of claim 6 wherein said at least one tow arm when in said towing position extends in a rearward direction from the work vehicle, and wherein said at least one tow arm when in said retracted position extends in a forward direction.

11. The towing apparatus of claim 6 wherein said at least one tow arm comprises a tow arm formed of a first part and a removable second part securable to said first part, wherein a first end of said first part includes said pivot connection to the work vehicle, wherein a second end of said first part fits in telescoping relationship with a first end of said second part, and wherein said hitch member is on a second end of said second part.

12. In a self-propelled work vehicle adapted to be towable between job sites directly on a road at highway speeds behind an automobile-type towing vehicle, a towing apparatus comprising:
a first tow arm pivotally connected to a frame of the work vehicle;
a second tow arm pivotally connected to the frame of the work vehicle;
said pivotal connections of said first and second tow arms to the frame located on opposite sides of a longitudinal centerline of the work vehicle;
each of said first tow arm and said second tow arm swingable about its respective said pivotal connection to the frame between first and second positions, wherein said first position is a rearwardly extending position at which said first and second tow arms are interconnected for work vehicle towing, and wherein said second position is a swept forward position for work vehicle operation; and
a hitch member on said first tow arm and connectable to a complementary hitch element on the towing vehicle when said first tow arm is arranged in said rearwardly extending position.

13. A work vehicle comprising:
a body having a forward end, a rearward end and a length extending between said forward end and said rearward end, said body including an operator station;
at least one lift arm assembly movably mounted to said body to raise and lower a materials handling attachment at said body forward end;
a tow element at said body rearward end for connection to an automobile-type towing vehicle behind which the work vehicle is towable between job sites directly on a road at highway speed;
ground engaging means at first and second locations along said body length, said ground engaging means at said first location including first and second ground engaging drive wheels respectively disposed on opposite sides of the body and convertible between a self-propelling mode and a free-wheeling mode, said first and second ground engaging drive wheels when in said self-propelling mode being operably connected to at least one work vehicle motor and controllable by an operator in said operator station to self-propel the work vehicle around a job site;
a first rack member located on said body rearward of at least one of said first location and said second location;
a second rack member located on said body forward of said first rack member; and
a plurality of weights adapted to be loaded on either of said first rack member and said second rack member, said plurality of weights selectively movable between said first and second rack members to adjust a weight distribution of the work vehicle, wherein said plurality of weights when loaded on said first rack member serve as a counterweight to the materials handling attachment during self-propelling of the work vehicle, and wherein said plurality or weights when loaded on said second rack member serve to limit weight acting down on the tow element during towing.

14. The work vehicle of claim 13 wherein said first location is forward of said second location, and wherein said first rack member is located on said body proximate said second location.

15. The work vehicle of claim 14 wherein said second rack member is located on said body proximate said first location.

16. The work vehicle of claim 13 wherein said plurality of weights comprises a first weight and a second weight, wherein each of said first weight and said second weight comprises a notch which fits over said first rack member to mount said first and second weights on said first rack member.

17. The work vehicle of claim 13 wherein said plurality of weights comprises a plurality of plates each with a notch formed in an edge, said notch of each plate structured and arranged to fit on said first rack member such that a center of mass of said plate is horizontally spaced from said first rack member.

18. The work vehicle of claim 13 wherein said second rack member is movable relative to said body between a retracted position and an extended position, wherein when in said extended position said second rack member extends within said operator station for loading of said plurality of weights.

19. The work vehicle of claim 18 further comprising means for locking said second rack member in said retracted position and said extended position.

20. A work vehicle comprising:
a body having a forward end, a rearward end and a length extending between said forward end and said rearward end, said body including an operator station;
at least one lift arm assembly movably mounted to said body to raise and lower a materials handling attachment at said body forward end;
a tow element at said body rearward end for connection to an automobile-type towing vehicle behind which the work vehicle is towable between job sites directly on a road at highway speed;
ground engaging means at first and second locations along said body length, said ground engaging means at said first location including first and second ground engaging drive wheels respectively disposed on opposite sides of the body and convertible between a self-propelling mode and a free-wheeling mode, said first and second ground engaging drive wheels when in said self-propelling mode being operably connected to at least one work vehicle motor and controllable by an operator in said operator station to self-propel the work vehicle around a job site; and
a ballast tank with a fluid fillable internal volume located on said body rearward of at least one of said first location and said second location, said tank having at least one opening in communication with said internal volume for inletting and outletting fluid, wherein an introduction of fluid into said tank internal volume through said at least one opening at a job site provides a counterweight to the materials handling attachment during self-propelling of the work vehicle, and wherein a draining of fluid from said tank internal volume through said at least one opening reduces vehicle weight for towing between job sites.

21. The work vehicle of claim 20 wherein said at least one opening includes an inlet in an upper portion of said tank, and a outlet in a lower portion of said tank, said outlet further comprising at least one of a removable plug and a valve to control fluid drainage.
